(19) United States
(12) Patent Application Publication
(10) Pub. No.: US 2011/0206351 A1
(43) Pub. Date: Aug. 25, 2011

(54) VIDEO PROCESSING SYSTEM AND A METHOD FOR EDITING A VIDEO ASSET

(75) Inventor: Tal Givoly, Irvine, CA (US)

(73) Assignee: Tal Givoli, Irvine, CA (US)

(21) Appl. No.: 12/712,298

(22) Filed: Feb. 25, 2010

(51) Int. Cl. G11B 27/00; H04N 5/93

(52) U.S. Cl. 386/283

(57) ABSTRACT

A video processing system and a method for editing a video asset, the method includes: obtaining a video asset of a first resolution; compressing, by compressing module, a video asset to provide a compressed video asset of a second resolution that is lower than the first resolution; transmitting, by a transmitter that is a hardware component, the compressed video asset to a remote video editor; requesting the remote video editor to edit the compressed video asset; receiving editing instructions from the remote video editor, the editing instructions are generated by the remote editor when editing the compressed video asset; processing, by a video processor, the video asset based on the editing instructions to provide an edited video asset; and performing at least one of storing, displaying or publishing the edited video asset.

### BACKGROUND OF THE INVENTION

Video editing of a video asset (any resolution, including standard or high definition) is a rather complex and time consuming task. Most consumers are either unwilling or unable to perform this function independently. Modern video editing software makes this task easier. However, it is still very time consuming. One must go over the entire video multiple times, make a lot of decisions, and spend many hours to get a desired outcome. In order to do so they must master many software options of video editing software they might use. Also, most owners of camcorders and other means of recording video are not professional videographers. That is, the footage they shoot originally is of inconsistent quality. This does not prevent them from purchasing camcorders, cameras, phones, PDAs, and other consumer electronics devices capable of capturing video and audio. Consumers record hours of video footage. Playing back all the long footage is an unwieldy operation. For most purposes, the raw footage is not very useful. Nevertheless, people record the content in order to “capture the moment”.

A user that is willing to edit his own video need to perform the following steps:

a. The user records video footage, typically at DVD, DV, MiniDV, HDV, High definition, quality on a camcorder, video-capable camera, camera phone, PDA, computer, webcam, and the like.

b. Optionally stores, on the user's computer, pictures or audio (e.g. music), either downloaded from the camera or acquired by other means.

c. Optionally downloads and/or installs of editing software for editing the video.

d. Optionally transfers the video content from the video recording device to the computer mass storage.

There are professionals video editors to which one can bring the raw footage (on digital or analog video tapes, digital mass storage such as hard drives or other memory storage devices), and the professional video editors can produce professional clips from the raw footage. However, this is very expensive since the skills, tools, and time required by the professional editors is significant as well.

It might be desirable to either completely automate the editing process, or at least, to relocate the professional human labor, so that it will be performed in a location where the cost of labor is cheaper—such as “off shore”—to developing countries or regions or any area where the cost of such professional labor could be substantially lower. However, this requires moving the raw footage from the consumer location to the professional location. For modern, and/or high definition, video content, this requires very huge amount of bandwidth for the data transferring. High definition content is typically recorded at a rate of several Mbps and even dozens of Mbps. Most consumer broadband connections are asynchronous and allow much less bandwidth in the upstream direction that limits the content upload ability. Transferring hours of footage to a remote location would overwhelm the internet broadband connection of most consumers. Furthermore, it would strain the network capacity for broadband access providers, or cost a lot for access providers that charge based on the actual usage (either bandwidth, aggregate data transferred, or peak capacity—any form of usage measurement)

An alternative to a transmission of the data from the consumer to the editor via network connectivity is to send the physical media itself, for instance, via general mail or delivery services. This has some disadvantages as well, such as the time and cost it takes to transfer the physical media. Some of the recorded footage is recorded on hard drives or flash drives within the camcorder—so they are not detachable from the camera. High performance removable storage such as flash-based memory cards that can be used to record high definition video content may be expensive and the consumer would not want to send the physical storage device to the video editor. It might also be that the raw footage would not have back-up copies, and the person sending them might not have convenient means to backup the material before sending it. So sending the recorded video files has an advantage over sending the physical storage.

Therefore, it is desirable to create an effective link for transferring high volume of video footage between consumers that owns video footage and fully automated, partially automated, or low-cost manual professional work without consuming significant amount of bandwidth of a broadband connection, as well as avoiding transmission of physical media (e.g. DV, MiniDV, HDV, DVD, BluRay, hard drive, memory storage, etc).

### SUMMARY OF THE INVENTION

A video processing system and a method for editing a video asset, the method includes: obtaining a video asset of a first resolution; compressing, by compressing module, a video asset to provide a compressed video asset of a second resolution that is lower than the first resolution; transmitting, by a transmitter that is a hardware component, the compressed video asset to a remote video editor; requesting the remote video editor to edit the compressed video asset; receiving editing instructions from the remote video editor, the editing instructions are generated by the remote editor when editing the compressed video asset; processing, by a video processor, the video asset based on the editing instructions to provide an edited video asset; and performing at least one of storing, displaying or publishing the edited video asset.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, of a video processing system, according to an embodiment of the invention;

FIG. 2 is a flowchart of a method for editing a video asset at a user site, according to an embodiment of the invention;

FIG. 3 is a flowchart of further features of a method for editing a video asset at a user site, according to an embodiment of the invention;

FIG. 4 is a flowchart of a method for editing a video asset at a video editor site, according to an embodiment of the invention;

FIGS. 4A-4D are flowcharts of video editing processes that are handled in a client site, according to an embodiment of the invention;

FIGS. 5A-6E are flowcharts of video editing processes that are handled in a video editor site, according to an embodiment of the invention; and

FIG. 6 illustrates a flowchart of a method for providing a marketplace for video editors, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following description the term “resolution” refers to either or all of: (i) The number of pixels in a frame (for instance, VGA resolution is 640×480); (ii) pixel density (dots per inch (DPI)); (iii) frame rate; and/or (iv) compression level. The term “high definition”, used in this specification, refers to high resolution as defined above, i.e.: large number of pixels, high pixel density, high frame rate, low compression level/non-compressed video and so on. Similarly, the term “lower resolution” refers to an encoding that results less bits, less bytes, less volume capacity and/or less bandwidth consuming multimedia.

Non-limiting examples of these terms may include the following: (i) a high resolution media stream includes a media stream of 640×480 pixels per frame and 30 frames per second, with MPEG2 compression while the low resolution includes a video stream of 320×240 pixels per frame, 15 frames per second, with MPEG2 compression. (ii) both media streams can be regarded as lower resolution versions of a video recorded at 1920×1080 pixels per frame, 25 frames per second, and AVCHD compression at or about 20 Mbps bandwidth. (iii) lower and higher resolutions can be also represented by higher frame rate that are accompanied by lower frame pixel density, by frame rate and pixel size of each frame is higher, but the compression is also higher.

It is noted that higher and lower resolutions can also refer to higher or lower fidelity or definition.

Higher and lower resolution can also refer to the size of memory space required to store a media stream, bandwidth or bit rate required to transmit it.

Lower and higher resolutions can be associated with different compression algorithms that can make a video consume less storage yet be of higher overall quality (for instance, MPEG4, DivX or Xvid often produce better perceived results with less bits than MPEG2 for the same size of frames and frame rate).

It is noted that the mentioned below systems and method apply mutatis mutandis to audio streams and to a combination of audio and video streams.

A video processing system and a method for editing a video asset is provided. The system includes software running on a personal computer, or a handheld device (mobile phone, PDA, camera, camcorder) of the consumer—this software compresses the video asset of a first resolution, typically a high definition resolution, into a second resolution, as to provide a compressed video asset. The second resolution is a low resolution which might be, for instance, 320 pixels wide, 240 pixels high, and 15-20 frames per second, when using an aggressive compression scheme. Therefore, reducing the bandwidth (and overall volume) of the video asset from 8-25 Mbps (for instance) down to less than 300 Kbps (in this example, reaching a 25-75x compression). This would facilitate a transmitting of the compressed video asset to a remote video editor over conventional broadband connections and will reduce the cost.

After the transmitting, either one of automated, semi-automated, or manual work (by humans) can be remotely utilized for editing the compressed video asset. However, the remote video editor would only have a compressed version of the original video. This would allow the remote video editor to edit the video—but not to render the final quality result. In order to regain the high resolution video quality, the original video asset must be re-processed.

The remote video editor edits the compressed video asset using a video editing software. They might cut the compressed video asset, add titles, sub titles, transitions, move footage around, incorporate pictures, replace and/or mix audio and narration and any other video editing function.

The result of the video editing at the remote video editor (either automated, semi-automated, or manually) would be of a low resolution—which would not be sufficient for many purposes. Therefore, the result of this video editing will be stored as an editing instructions, which is a meta-data describing the video editing functions performed. The editing instructions will be sent back to the computer (or compute element) on which the original, high definition, video asset resides (typically the consumer's personal computer). A video processor will process the original high definition video asset based on the editing instructions received from the remote video editor as to provide an edited video asset of the original resolution or any other desired resolution, depending on the intent of the user.

It is very likely that the edited video asset that is provided by the first round of editing would not be exactly as desired by the consumer. Therefore, the following additional mechanisms are introduced.

According to an embodiment of the invention, client editing information that includes further definitions is sent to the remote video editor along with the compressed video asset. The client editing information includes many aspects related to how the video should be rendered—including, but not limited, to the following:
(i) The name of the video asset (title of the event/project).
(ii) The date or date range in which the video asset was obtained.
(iii) A type of event that is captured by the video asset, for instance, a birthday, wedding, anniversary, party, graduation, performance, ceremony, trip, play, concert, dance, home video, and the like.
(iv) Items of interest captured in the video (e.g. the main actors that need to be focused on).
(v) An importance of a dialogue captured in the video asset (for instance, is a particular speech very important, or can it be overlaid with music)

According to another embodiment of the invention, additional material can be sent to the remote video editor: pictures and text to be included in the video asset, additional video, or audio material that need to be incorporated into the video asset. For instance, if there is a group photo of a graduation video, it could be specified and provided as a mandatory photo to be incorporated into the edited video asset.

According to yet another embodiment of the invention, the client editing information that is sent to the remote video editor, further includes specification for one or more desired format and desired style of the edited video asset. The desired format would imply the quality of the edited video asset as well as the desired range of durations of the edited video asset (for instance, a 5 minute video clip, a 15 or 30 minute clip, etc.). The desired style might be a selection from a set of offered choices. The style might be any of but not limited to: whimsical, childish, romantic, professional, and the like.

Part of the parameters of the client editing information can be defined in a later phase, for instance, the quality of the edited video asset might be determined later on and not as part of the first transmission, e.g. the video can be edited and ready for producing multiple quality outputs upon user discretion later on.

The video asset can be rendered on the client's personal computing device (e.g. personal computer) in any resolution.

After the video is rendered, (i.e. the video asset is processed based on the editing instructions to provide the edited video asset) the user will optionally have the ability to provide editing remarks (i.e. feedback) regarding the result. Further iterations of the editing and review/feedback stages are possible.

The user would be able to view the video, annotate the video and provide comments. These comments can be generic, or can be related to specific portions of the video in terms of time, or even partial areas of the screen. The art of video annotation is known (and available, for instance, on YouTube). Therefore, an edited second resolution video asset (wherein the second resolution is a lower-resolution of the edited video asset) will be made available for annotation by the user, by loading to a private section on YouTube or other video editing services, or can be hosted by a provider of the editing capabilities themselves.

The remote editor (either automatically, semi-automatically, or manually) considers the editing remarks and annotations received from the user, and subsequently incorporates these changes and creates another edition of the video asset. This produces meta-data with updated editing instructions that is sent to the client computer to render the video in full resolution as to provide a re-edited video asset.

As a result of the described comprehensive process, large volume of high resolution video can be converted from the raw footage of the original video asset that is rarely being watched to highly valuable high quality professionally edited video asset using a process that requires minimal manual effort by the user that recorded the video.

Corporations might also use the invention so as to outsource the creation of videos that document events, training sessions, conferences, lectures, presentations, meetings, video conferences, etc. This eliminates the dependency on highly paid employees or contractors by using a low cost processing (which is either fully or partially automated—or manually performed).

The following description refers to a client site (also referred to as a ‘user site’) and a video editor site. The terms ‘user site’ or ‘video editor site’ may refer to a physical location as well as to a logical location, computer, station, premise associated with a user or a video editor, respectively. Most often, the “user site” will be different from the “video editor site”, but this is not necessarily so and both sites can share the same geography, location, or site.

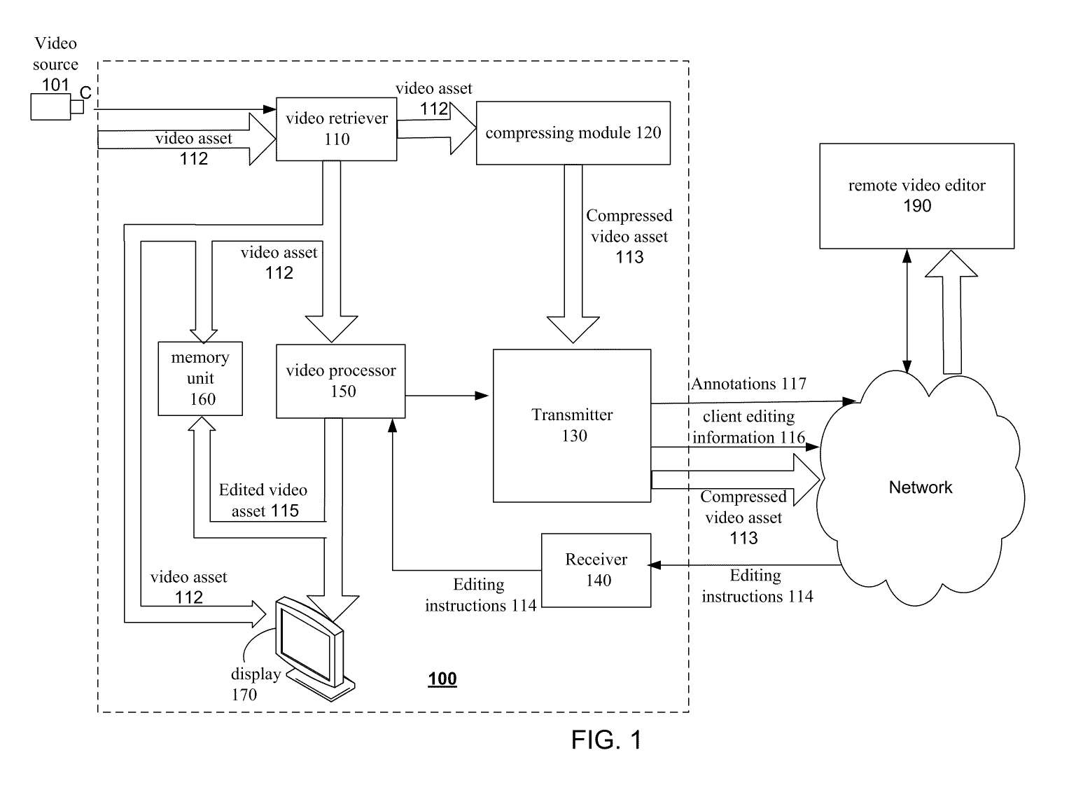

FIG. 1 illustrates a video processing system 100 at a client site, that includes: a video retriever 110 for obtaining a video asset of a first resolution 112. Video retriever 110 is connected to a video source 101, such as, for example: a camera, a camcorder or any other video recording device. The video source can be coupled to video retriever 110 via any type of wired connection, such as but not limited to: USB, FireWire, eSATA, Ethernet and the like, or a wireless connection, such as but not limited to: WiFi, Bluetooth, proprietary wireless protocol, or any other cellular or wireless protocol. Video asset of a first resolution 112 may be a non compressed video asset but this is not necessarily so, as video source 101 may provide a compressed video asset; a compressing module 120 for compressing video asset 112 as to provide a compressed video asset of a second resolution 113 that is lower than the first resolution; a transmitter 130 for transmitting to a remote video editor 190: compressed video asset 113, client editing information 116, Annotations 117 or any other media or meta-data information; a receiver 140 for receiving editing instructions 114 from remote video editor 190, editing instructions 114 is a meta data that is generated by remote video editor 190 when editing compressed video asset 113; a video processor 150 for processing video asset 112 based on editing instructions 114 to provide an edited video asset 115; a memory unit 160 for storing edited video asset 115 and optionally storing the original video asset 112; and a display 170 for displaying edited video asset 115 and optionally displaying the original video asset 112.

Video processing system 100 of the client site further includes the following described software components.

A client software—can include all the functions or can be separated to multiple software packages, each includes part of the functions. The client software (or the multiple software packages) can be installed as a stand alone software on the client desktop, or can be downloaded from a web site and run as an applet/agent within web browsers, or be installed as a daemon in the background on the client station. The client software (or packages) may include the following functions, although it may include only part of the functions or any other functions that are related to: video importing, saving, processing, transferring and the like.

(i) Importing or copying video asset 112 from the video recording device to the computer is done by video retriever 110.

(ii) Compressing the original high definition video (from original recorded resolution to a low resolution suitable for transferring) is done by compressing module 120.

(iii) Transmitting the low resolution video to the editing location—by transmitter 130.

(iv) Receiving user input regarding the desired video output: allowing identifying the raw footage of video asset 112, and many other parameters about the desired edited video asset.

(v) Saving personal preferences for future invocations, so that future videos can share some of the personal preferences of the user submitting the video (such as name, author, folders/directories from which the video is collected, and many other stylistic and other personal preferences).

(vi) Receiving editing instruction 114 (meta-data) from remote video editor 160. This might include various executable modules for specific rendering functions. This might also include any additional pictures/audio or transition pictures—that are required in order to render the video.

(vii) Rendering of the video—applying the received editing instruction 114 and applying it on video asset 112 of the first (uncompressed) resolution (plus full resolution of any associated pictures and audio material).

(viii) Software update—the software can check for software updates and be updated so as to resolve defects and improve the software.

(ix) Publish—an ability to upload edited video asset 115 to video sharing sites (YouTube, Facebook, Myspace, and others).

(x) Annotation—an ability to present a preview of the video (rendered in either draft resolution/quality or final desired quality/resolution) and collect feedback from the user—when the annotation process is completed, the annotation meta data can be sent to remote video editor 190.

In the remote video editor site, like the client side, many functional capabilities are required. These can be incorporated and combined in any combination of software applications/systems. The remote video editor site may include the following functions, although it may include only part of these functions or any other functions that are related to video editing:

(i) Receiving compressed video asset 113 (or alternatively the uncompressed video asset), including configuration/preference data regarding the desired edited video asset, important data about the video itself, the desired results, and other preferences.

(ii) Editing the video—by professional video editors that edit compressed video asset 113 according to the instructions (client editing information) provided by the clients. The editing can be either a manual editing, a semi-automatic editing or a full automatic editing.

(iii) Creating editing instruction 114 (meta-data) that is sent to the client for rendering and/or annotation.

(iv) Receiving annotation package from client.

(v) Automated scene detection.

(vi) Automated beat detection in audio segments.

(vii) Providing templates of video editing—so that style, transitions, titles, and others are selected from a palette of options, reducing the creative range for a specific video segment based on practices known in advance. It is expected that the video editor that edits a video will select a template and use it along the editing. The templates may be created by other designers to be used by the video editors. The templates can be used by either Human video editors or software.

(viii) Automated video editing—some or all of the functions performed by human video editors can be automated. It is anticipated that over time, more and more of the functions of the editing will be performed by software/machine, assisting the creation of the final edited video. Some examples of functions that are known today to be automatable are: Face detection, Scene detection, Shake prevention, Color correction, Audio improvements and adjustments, Beat detection, Poor quality video identification (due to over or under exposure, composition, shakes, and the like), and many more.

The automated portion of video editing will off load functions that are done by human to the software and help humans complete the tasks. Ultimately, all the functions performed today by humans related to video editing might be automated. However, some of these functions are not yet feasible for high quality video production.

Remote video editor 190 may further include a management function that enables managing the remote clients, the tasks of the video editors, the status of all the orders/activities, to define the service level agreements (SLAs) or any contract or the client's requirement/expectations, and many more. For example, a user submitting a video asset should get time estimation for receiving the resulting editing. The time estimation function will measure and anticipate the queues of work load vs. the capacity, the nature of the specific job, the computation capabilities of the client computer, etc. in order to provide an SLA. The system may monitor the committed SLAs, raise alarms, take corrective action steps, and more. Also, all software updates to remote clients should be managed.

According to an embodiment of the invention, the video editing includes the following steps:

a. Obtaining, by video retriever 110, the video asset from either of the sources: (i) a video footage location on a mass storage of the computer or handheld device; and (ii) a raw video from a video recording device. Video retriever 110 will guide the user to connect the video recording device containing the raw footage, and help the user transfer the raw video footage from the device. The transferring of the raw video footage can use any type of connection topology, such as a point to point connection or a network connection and can use either a wired connection or a wireless connection.

b. Collecting parameters about the project, preferences, identifying additional material (video, pictures, audio), selecting main characters, themes, the desired output format/length etc.

c. Compressing the large volume of video content and optionally compressing additional picture, audio and video content, if they are large too.

d. Sending to the remote video editor, the compressed video asset and a client editing information (meta-data) that includes the parameters provided by the user.

e. At the remote video editor site, the job is handed to automated, semi-automated, or manual processing.

f. Editing the received compressed video asset and storing the editing instructions as a meta data.

g. Sending the editing instructions to the client computer.

h. Receiving, by the client computer, the editing instructions, and rendering the edited video asset, as a background process of the computer.

i. Optional annotating the edited video asset.

j. the edited video asset is rendered in background, at the desired quality and outputs that was chosen by the user.

k. Optionally publishing to an online storage.

The stage (i) of annotation includes the following steps: the user is presented with an annotatable video, in which he can enter annotations; The annotations are packed as a set of data and sent to the remote video editor; The remote video editor considers the annotations and produces another meta data—annotation related editing instructions for rendering the video; The annotation related editing instructions are sent to the user; Typically the client software renders the video in a background process but this is not necessarily so and the rendering can use a foreground process. The annotation steps can be repeated until the user is satisfied with the result.

After using the video editing process, the edited video asset is available for burning on DVD/BluRay/computer hard drive in computer-readable form, or published on the internet.

After step (d) of sending to the remote video editor, the user can be informed of the estimated time for expecting the result (based on computation power, bandwidth between the client computer and network-hosted servers, and capacity and workload of the editing location. The user can also get a quotation for the editing. The quotation can be added to the user charging account.

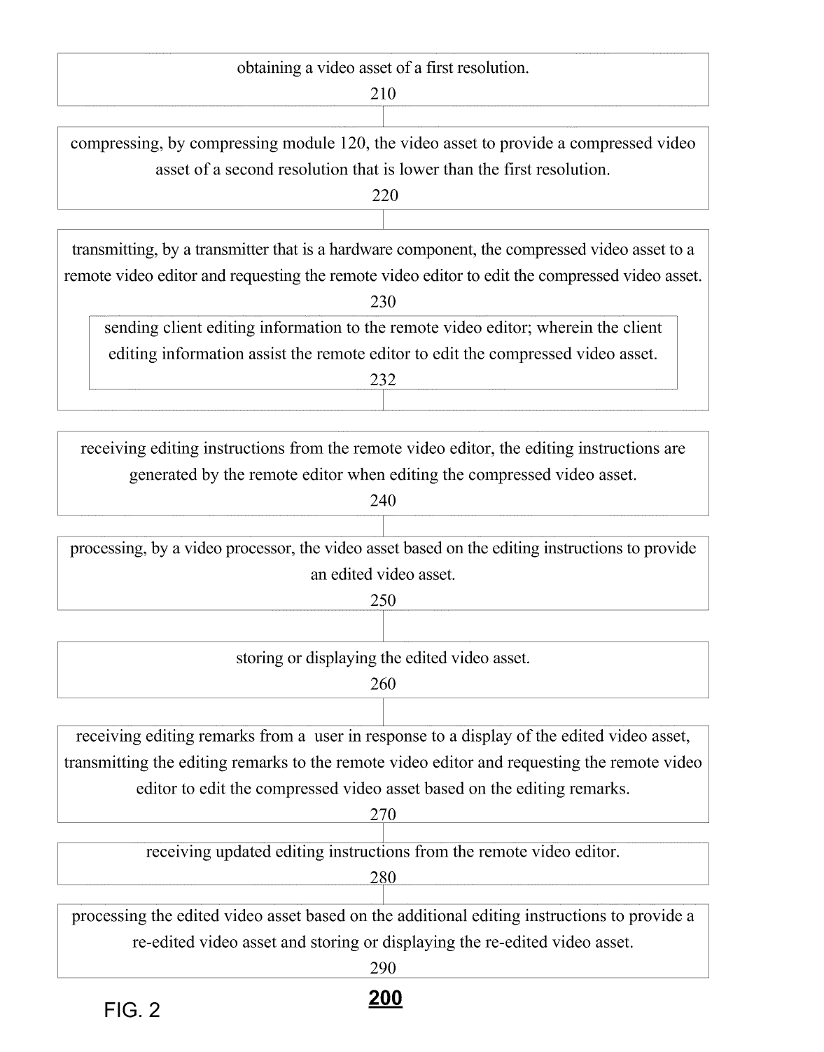

FIG. 2 illustrates a method 200 for editing a video asset. Method 200 starts with stage 210 of obtaining a video asset of a first resolution. The first resolution may be a high resolution and the video asset is typically a non compressed video footage, but can also be a compressed video.

Stage 210 is followed by stage 220 of compressing, by compressing module 120, the video asset to provide a compressed video asset of a second resolution that is lower than the first resolution.

Stage 220 is followed by stage 230 of transmitting, by a transmitter that is a hardware component, the compressed video asset to a remote video editor and requesting the remote video editor to edit the compressed video asset.

Stage 230 may include stage 232 of sending client editing information to the remote video editor; wherein the client editing information assist the remote editor to edit the compressed video asset. The client editing information may include: a name of the video asset, a date in which the video asset was obtained, text to be included in the edited video asset, a picture to be included in the video asset, and a desired length of the edited video asset, a type of event that is captured by the video asset, an importance of dialogue captured in the video asset, items of interest captured in the video asset, pictures of items of interest captured in the video asset, a desired format of the edited video asset, and desired style of the edited video asset.

Stage 230 is followed by stage 240 of receiving editing instructions from the remote video editor, the editing instructions are generated by the remote editor when editing the compressed video asset.

Stage 240 is followed by stage 250 of processing, by a video processor, the video asset based on the editing instructions to provide an edited video asset.

Stage 250 is followed by stage 260 of storing or displaying the edited video asset.

Stage 260 is followed by stage 270 of receiving editing remarks from a user in response to a display of the edited video asset, transmitting the editing remarks to the remote video editor and requesting the remote video editor to edit the compressed video asset based on the editing remarks.

Stage 270 is followed by stage 280 of receiving updated editing instructions from the remote video editor.

Stage 280 is followed by stage 290 of processing the edited video asset based on the additional editing instructions to provide a re-edited video asset and storing or displaying the re-edited video asset.

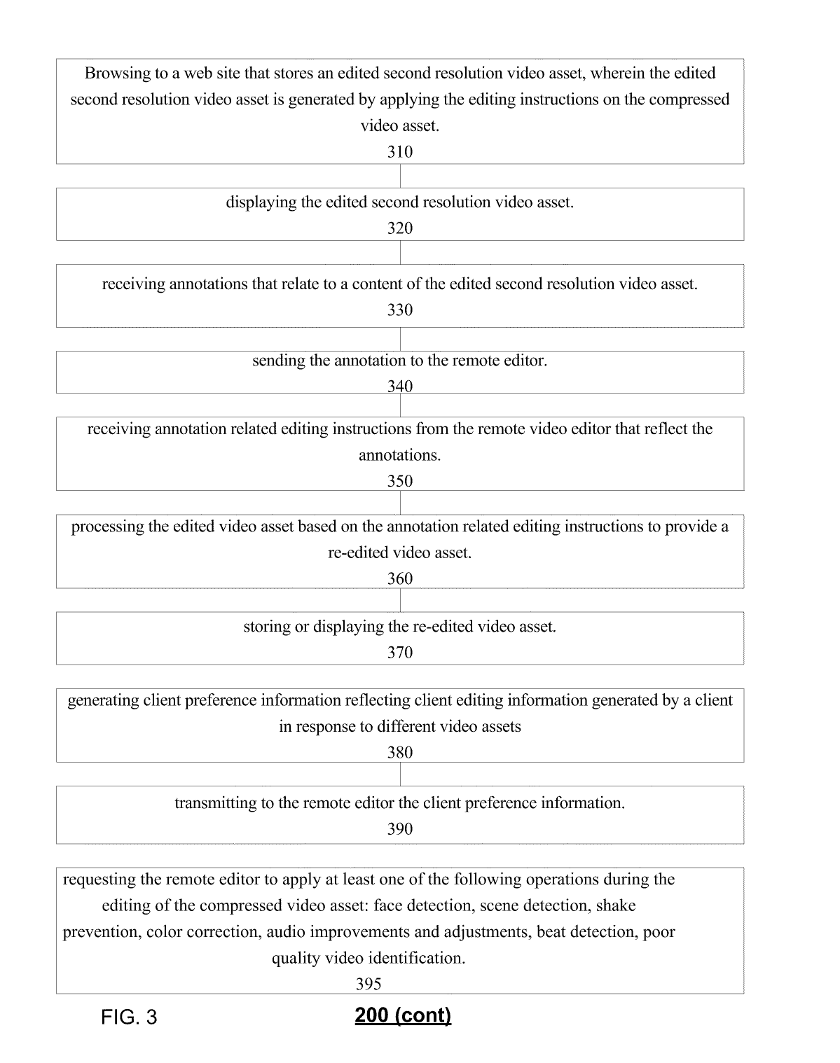

FIG. 3 is a flow-chart of further video editing options of method 200.

Method 200 may include stage 305 of uploading an edited video asset to video sharing web sites.

Method 200 may include stage 310 of browsing to a web site that stores an edited second resolution video asset, wherein the edited second resolution video asset is generated by applying the editing instructions on the compressed video asset.

Stage 310 may be followed by stage 320 of displaying the edited second resolution video asset.

Stage 320 may be followed by stage 330 of receiving annotations that relate to a content of the edited second resolution video asset.

Stage 330 is followed by stage 340 of sending the annotation to the remote editor.

Stage 340 is followed by stage 350 of receiving annotation related editing instructions from the remote video editor that reflect the annotations.

Stage 350 is followed by stage 360 of processing the edited video asset based on the annotation related editing instructions to provide a re-edited video asset.

Stage 360 is followed by stage 370 of storing or displaying the re-edited video asset.

Method 200 may include stage 380 of generating client preference information reflecting client editing information generated by a client in response to different video assets.

Stage 380 is followed by stage 390 of transmitting to the remote editor the client preference information.

Method 200 may include stage 395 of requesting the remote editor to apply at least one of the following operations during the editing of the compressed video asset: face detection, scene detection, shake prevention, color correction, audio improvements and adjustments, beat detection, poor quality video identification.

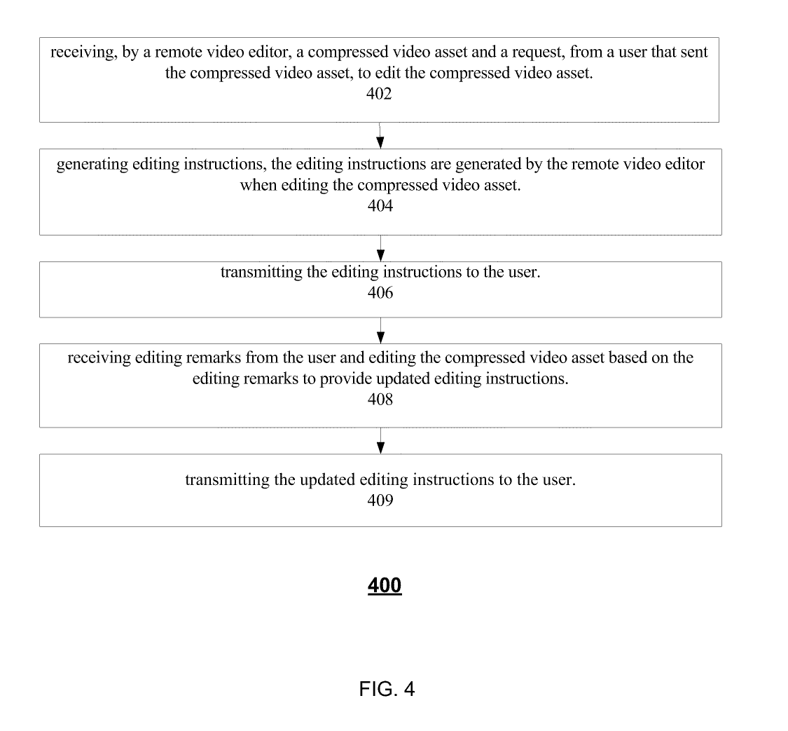

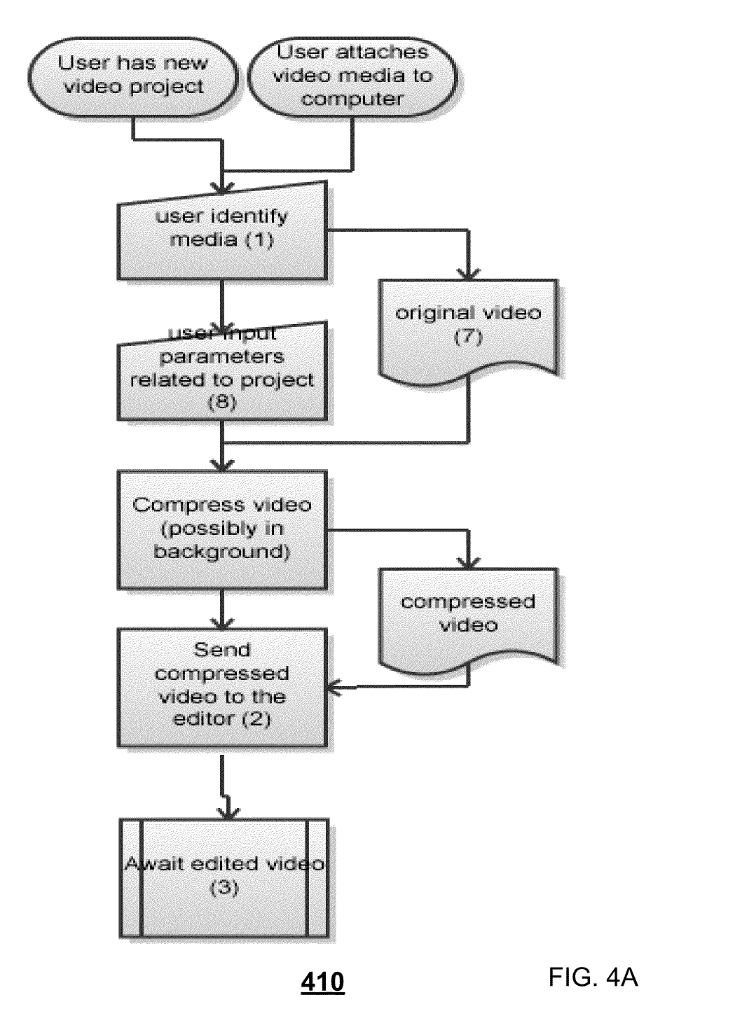

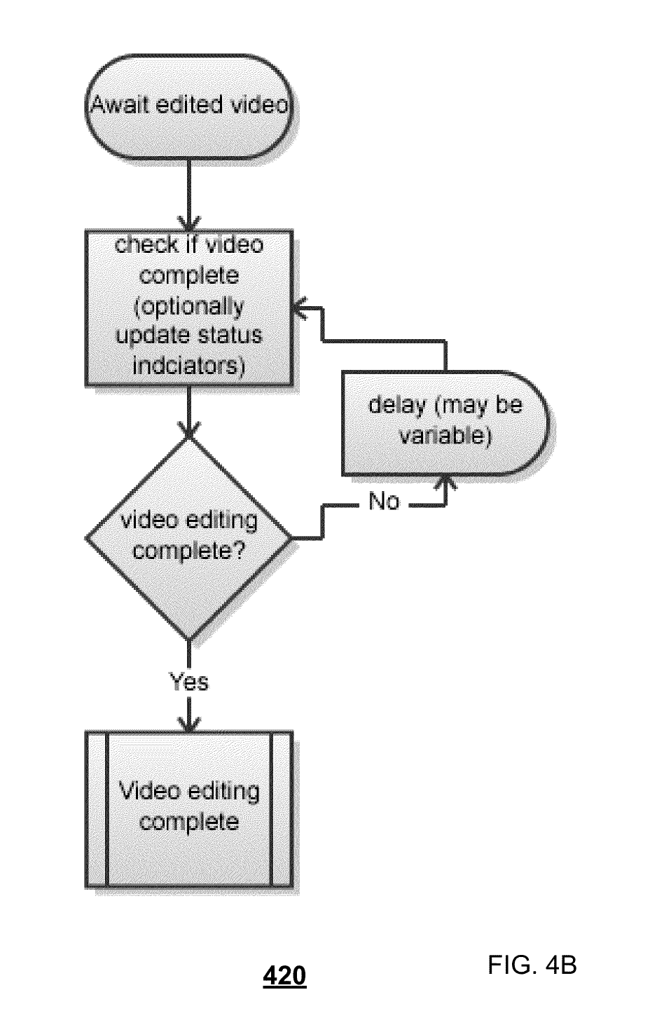

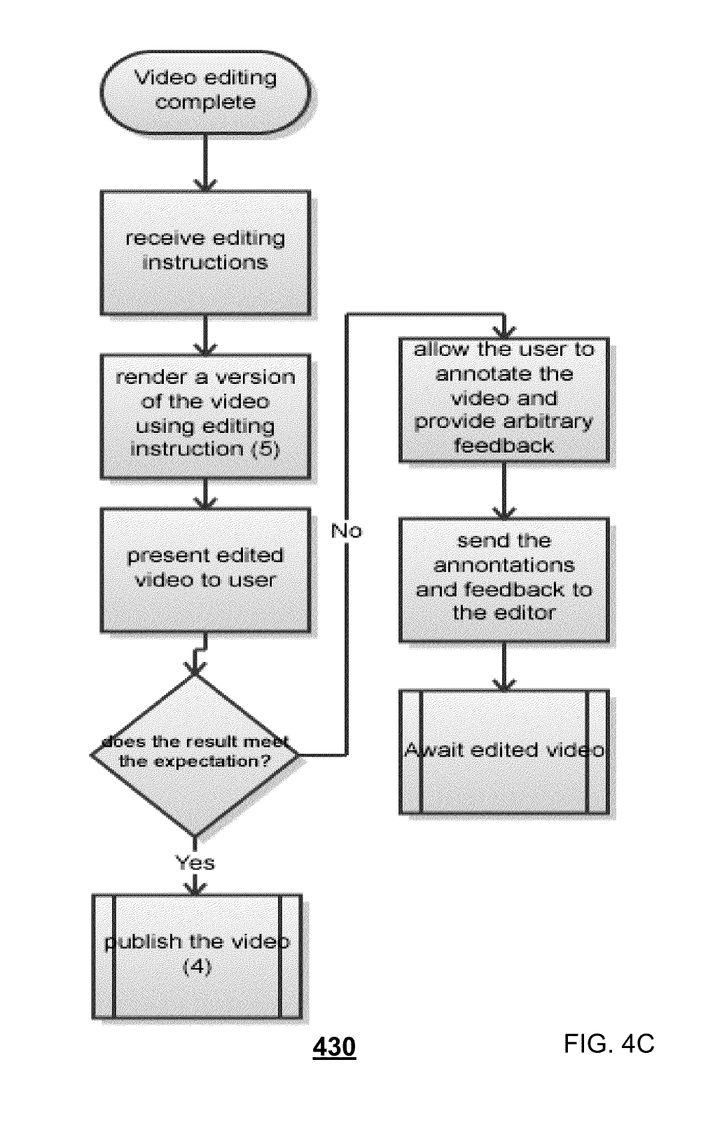

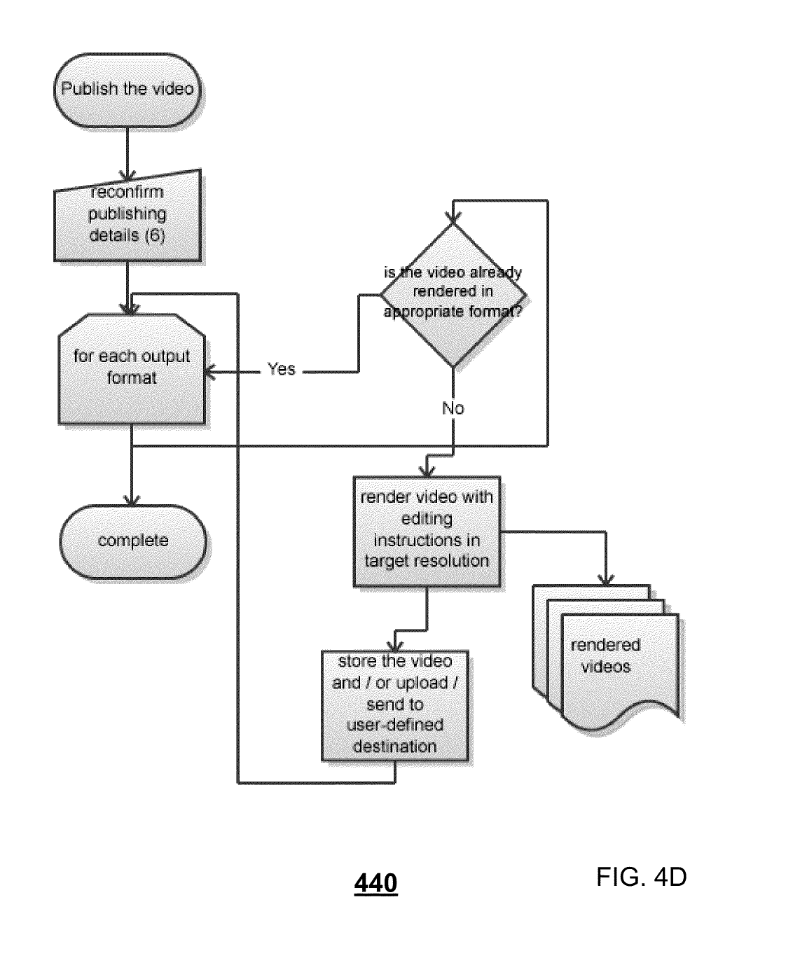

FIG. 4 illustrates a method 400 for editing a video asset. Method 400 is performed at the remote video editor site.

Method 400 start with stage 402 of receiving, by a remote video editor, a compressed video asset and a request, from a user that sent the compressed video asset, to edit the compressed video asset.

Stage 402 is followed by stage 404 of generating editing instructions, the editing instructions are generated by the remote video editor when editing the compressed video asset.

Stage 404 is followed by stage 406 of transmitting the editing instructions to the user.

Stage 406 is followed by stage 408 of receiving editing remarks from the user and editing the compressed video asset based on the editing remarks to provide updated editing instructions.

Stage 408 if followed by stage 409 of transmitting the editing instructions to the user.

FIGS. 4A-4D illustrate in greater details some of the processes that are carried out in the client site. FIG. 4A is a flowchart describing a process 410 of preparing a video asset for editing. Process 410 includes: attaching a media with the original video asset to the computer, identifying the media, defining the new project, compressing the video and sending the compressed video to the video editor.

FIG. 4B is a flowchart describing a process 420 of monitoring of the status of the video editing completion. This process includes a periodical checking of the status and announcing the completion of the video editing at the end.

FIG. 4C is a flowchart describing processes 430 that take place upon reception of the editing instructions, these processes include: rendering the edited video asset according to the received editing instructions, displaying the edited video asset to the user and optionally receiving feedback from the user that includes editing remarks, optionally allowing the user to annotate the video. If the user provided feedback or annotations—they are sent to the video editor, otherwise—the video can be published.

FIG. 4D is a flowchart describing a publishing process 440.

FIGS. 4A-4D illustrate numbers in parenthesis that corresponds to the following remarks:

(1) The video can reside on mass storage already, in which case the user simply selects the location of the files containing the video, or it can still reside on the video recording device. “user identify media” can be triggered implicitly by attaching the video recording device, or storage containing video media to the computer.
(2) “Send compressed video” transmits the compressed video file to a remote server over an arbitrary network, often the Internet.
(3) This initial sequence continues as the edited video is ready and retrieved from the remote servers. This box denotes a sub-process defined separately.
(4) Publish the video is a process that includes publishing/making public, and/or storage of the video in a format the user can use further to view the video, transmit it, or further process it.
(5) Any version of the video can be used in the rendering at this stage—it could be the original, not recompressed video (all video is typically compressed at some level to begin with), a more compact version, or the compressed version that was sent to the editor.
(6) The user may modify the parameters about the desired output (in terms of format, resolution, quality, destination, etc.)
(7) The original video may already be compressed. However, it usually still retains a lot of details. The compressed video here denotes compressing the video beyond its original resolution to make it more appropriate for transmission across a network.
(8) Additional steps are possible in this process to receive an estimate of when the project will be completed. Also, in this step the user can identify additional media, such as video, audio or pictures, that can be used in the creation of the final rendered video. These are not depicted in the most basic flow diagram.

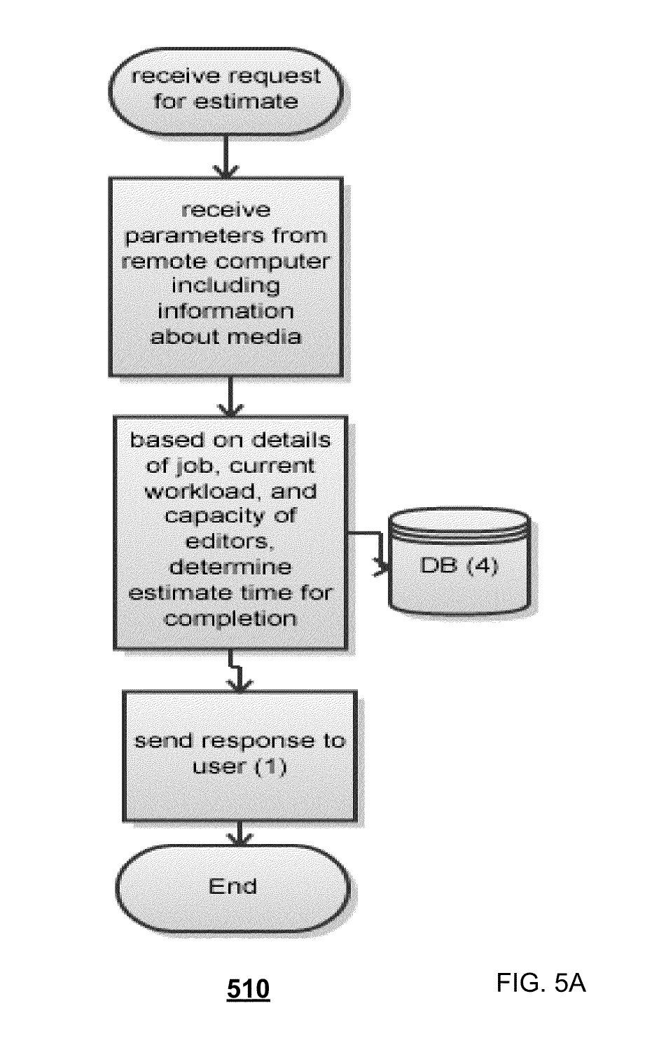

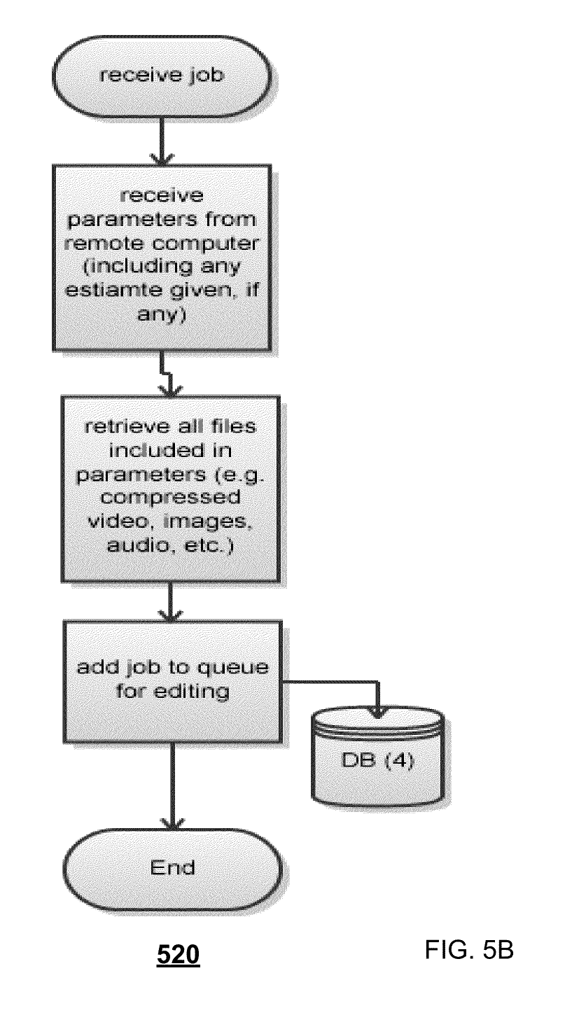

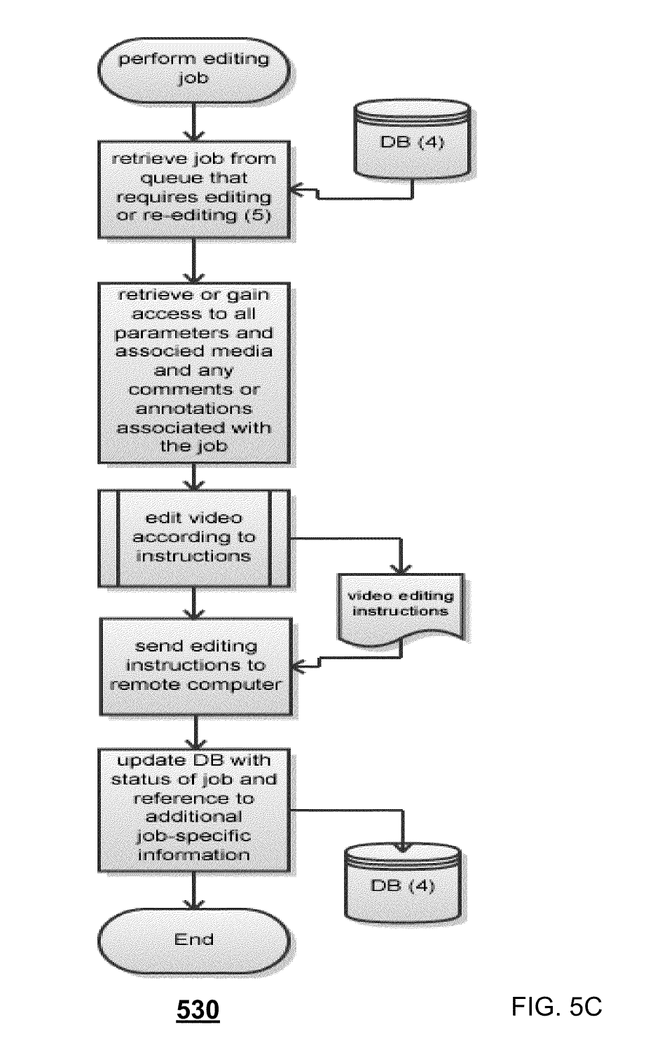

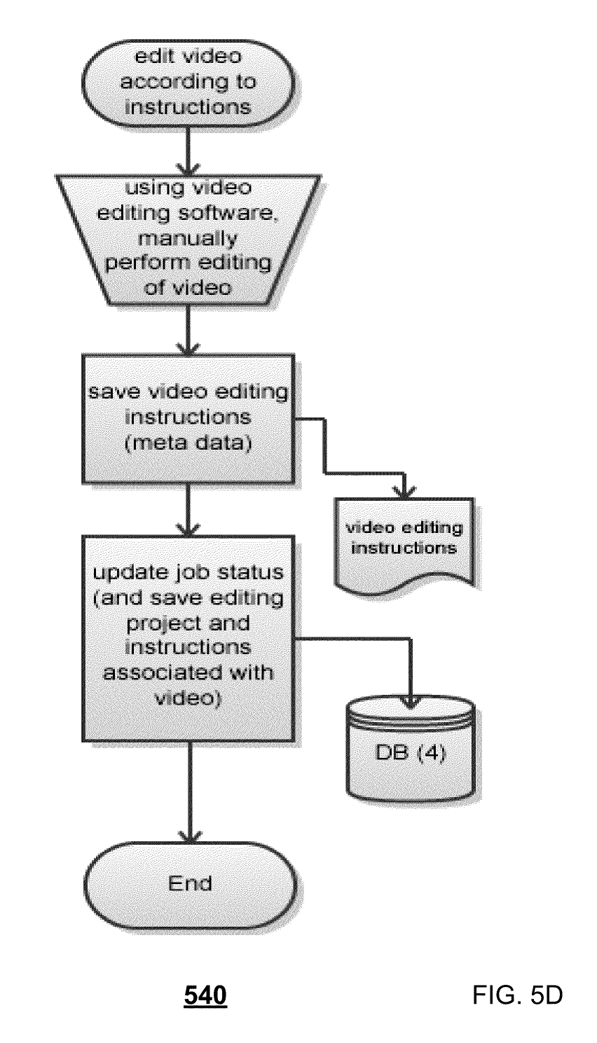

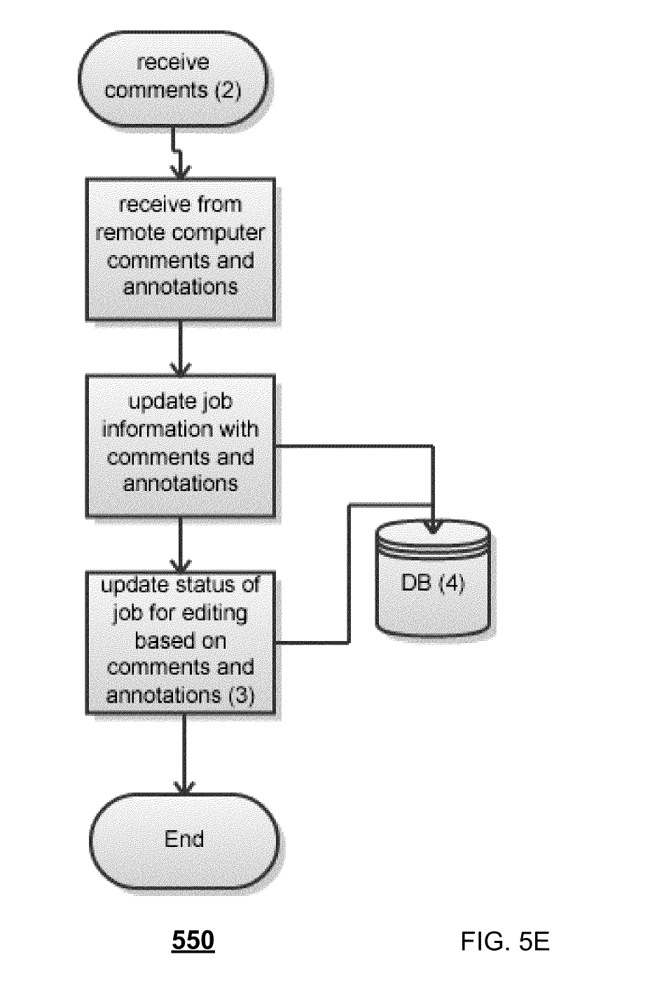

FIGS. 5A-5E illustrate in greater details some of the processes that are carried out in the video editor site. FIG. 5A is a flowchart describing a process 510 of optional time estimation for a video editing job. Cost estimation can also be included in the estimation.

FIG. 5B is a flowchart that describes a process 520 of receiving a new job that includes the compressed video asset to be edited and optionally additional files. The receiving includes queuing the job.

FIG. 5C is a flowchart that describes a process 530 of handling an editing job, including: retrieving the next job from the queue including all the associated files, editing the video asset retrieved from the queue. The results of the editing are the editing instructions that are sent back to the user that requested the editing.

FIG. 5D is a flowchart that describes an editing process 540.

FIG. 5E is a flowchart that illustrates a process 550 of another round of editing that includes: receiving editing remarks and/or receiving annotations and save it in the job queue for further processing by process 540 of editing.

FIGS. 5A-5E illustrate numbers in parenthesis that corresponds to the following remarks:

(1) Interactions with remote computer are using software running on the user's computer. It is possible that the software will process, display or present any information or video to the user.
(2) Whenever “comments” are mentions—it should be “comments and/or annotations”.
(3) This will cause “perform editing job” to take place when the job reaches the top of the queue for an editor.
(4) Generic term of DB/Database, refers to any storage that contains data that is retrievable, may be a single instance, or multiple instances, may be any form of association, may have files associated with detailed data that might reside in referenced storage. Primary role of the DB (but not exclusive) is to store the jobs, all details associated with the jobs (either directly within the DB or by reference), for example, it is possible that annotations, edits, media files, and others, are not stored physically in the same place as other data.
(5) The “perform editing job” and “edit video according to instructions” flows happen when jobs reach a state in the queue of requiring editing (they are either new or have received comments and/or annotations). In both cases, all available data about job is taken from the DB and the video is edited according to the desired instructions included within.

According to an embodiment of the invention, the client software may provide an access to a community of video editors (a virtual marketplace).

By virtue of the core video editing invention, it is possible to create a marketplace of video editing. Consumers who record video on any device will be able to choose a video editing service provider. More than one individual video editor or organization providing video editing services would be able to offer their services in a virtual (Internet-enabled) marketplace. The consumer would be able to select from a list of providers of video editing services. Further information could be presented to consumers to help them choose from amongst the available providers. For instance, the price list of the different offerings, reviews and comments by past customers of their services, sample results of their services, other advertised features, capabilities, or promotions, and more. The provider of the marketplace, the company or business entity that puts together the marketplace itself and incorporates all such providers of video editing services, and exposes their services to consumers is implementing a method and a system to aggregate such information from providers and to expose such services, including accompanying details to help consumers select from amongst the multiple video editing service provider.

Further, it is possible to perform an auction for video editing work to be performed. In this manner, the consumer can determine the price, parameters of the video editing job (quality, length, completion date/time and other parameters concerning the job) for a particular service he/she wants to be performed. The consumer then publishes such a request and any number of video editing service providers submit bids to provide the services at said terms.

However the agreement between the consumer and the video editing service provider is mediated via the marketplace, there are two basic methods by which the actual video editing can take place. In the first option, the marketplace host facilitates the interaction—whereby the compressed video and meta data flow between its servers and the selected video editing service provider—creating an abstraction of the consumer and the video editing service provider from one another. In the second option, once the consumer and a video editing service provider have agreed to the terms of a particular video editing job, the consumer and the video editing service provider interact directly—that is, the compressed video and various meta data interactions will be communicated directly between them and not through the marketplace provider.

In either of the above two cases, it is still possible that the financial clearing take place through the marketplace provider. For example, the marketplace provider will present a bill to the consumer, request means of payment (e.g. credit card information, PayPal, Google Checkout, bank account details for direct transfer, or any other means of payment), and complete the charge to the consumer means of payment. The marketplace provider would then pay either all, or an agreed-upon portion (some percentage of the consumer payment) to the video editing service provider. The payments could be done individually, per every video editing job, or they could be aggregated over a period of time, or an amount of money, or both. The financial exchange between the video editing service provider and the marketplace provider could take place using any means of electronic payment or money transfer.

The main benefits to consumers are of confidence, convenience, privacy and trust, as the consumer doesn't need to share his/her name, credentials, address, means of payment detail, or other information with arbitrary providers of video editing services—and instead, can trust the marketplace provider only. The consumer is presented all the means to compare between providers and interact with them, facilitated by the marketplace provider.

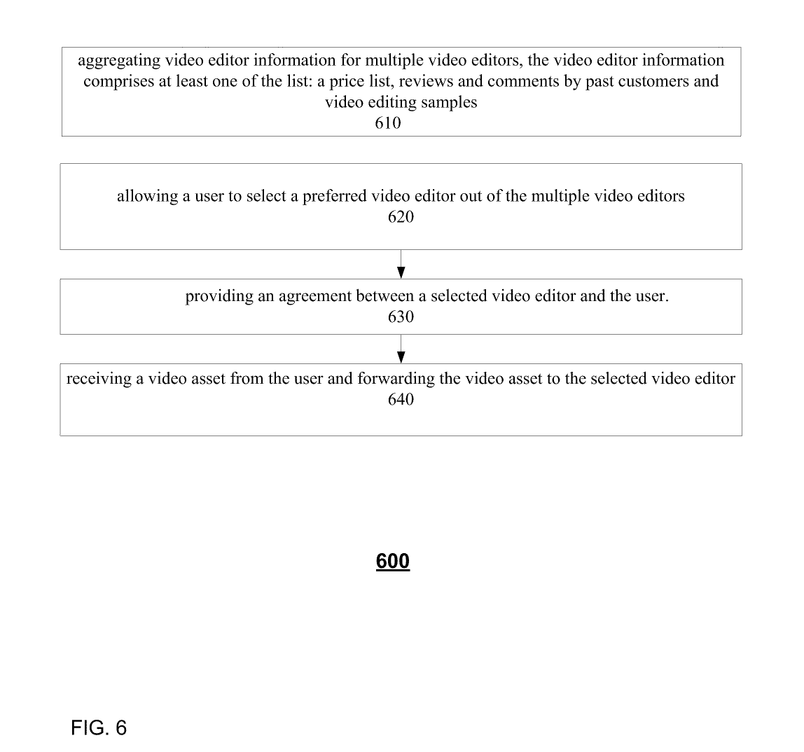

FIG. 6 illustrates a method 600 for providing a marketplace. Method 600 includes stage 610 of aggregating video editor information for multiple video editors, the video editor information includes information regarding the services supplied by the video editor, such as but not limited to: a price list for the services, reviews and comments by past customers and video editing samples, and the like.

Method 600 includes stage 620 of allowing a user to select a preferred video editor out of the multiple video editors. Stage 620 includes displaying a list of video editors and their corresponding information.

Stage 620 is followed by stage 630 of providing an agreement between a selected video editor and the user. Stage 630 may include a financial clearing as was previously set forth.

Stage 630 may be followed by stage 640 of receiving a video asset from the user and forwarding the video asset to the selected video editor.

An advertizing platform, e.g. an internet site, for professional or semi-professional video editors be established, enabling the video editors publishing their services, advertising and provide references, samples, and price quotes, promotions, and the like. Users can use the site for choosing the video editor that will edit their videos.

The video editing software may include advanced editing features, for example: identifying sequences where the pictures are blurred, out of focus, poor audio quality, identifying faces out of photo line-up, or identifying individuals, tracking faces in scenes, scene cutting and the like. The identifying of faces/individuals in the video may be done by face recognition/identification—wherein faces are uniquely identified and “exposed”. The identified faces can be presented to the user that will be able to select—and determine which faces are important and optionally associate a name/identification with the face. The feature of tracking faces can apply a correction of the light exposure of the selected individuals, change the brightness, the contrast and so on.

According to an embodiment of the invention, computing resource consuming processes that are part of the client software are implemented as background processes. The client software may have a user interface that can interact with the user, while the software is running as a background process, e.g. while rendering a video. The user interface can be activated, for example from a toolbar, a menu bar, a system tray icon, an icon, a foreground window, or any other typical way to present status and interact with running process, and it can have a resident portion and/or a foreground processing priority.

The client software may include a resident portion for monitoring background processes, such as: transmission, rendering, compression, packaging, progress and/or status monitoring, bandwidth utilization, computation resources, updates, software upgrades, any maintenance processes and the like.

The resident portion of the client software may be interacted either through a toolbar, icon, window, or any other visual indication. The interaction with the resident portion may use a GUI (Graphical User Interface), a command line, a script, or via another shell program.

The User Interface (UI) of the client software can provide interface for selecting video media, pictures, music, texts, and other parameters (e.g. style desired), for the requested job and an interface for reviewing results and annotation and provide feedback.

The client software may further include: capturing feedback from the user; determine output rendering and distribution; automatic tagging of photos, focus, and the like; Send and receive from distributed site the material and/or meta data; render, compress, transmit, receive, and publish/upload the edited video.

The editing location software can include: receiving job, managing queue, reviewing video transmitted, editing it, creating, modifying and using templates, creating meta data that reflects the edit, send, facilitate interaction between client and editor.

It should be noted that the term “high definition” used anywhere in this specification refers to any high quality video, such as but not limited to: HD as defined in high definition standards (720p, 1080i, 1080p), or it could be of higher or lower resolution, frame rate, compression mechanism, compression ratio, bandwidth, etc. Therefore, high definition in this context would include 960×540 pixels at 30 fps progressive video as well as ultra high definition format (which is about 4× the resolution of HD), and any other video format in between, below or above this resolution which may be considered as “high quality”.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for editing a video asset, the method comprises:
obtaining a video asset of a first resolution;
compressing, by compressing module, a video asset to provide a compressed video asset of a second resolution that is lower than the first resolution;
transmitting, by a transmitter that is a hardware component, the compressed video asset to a remote video editor;
requesting the remote video editor to edit the compressed video asset;
receiving editing instructions from the remote video editor, the editing instructions are generated by the remote editor when editing the compressed video asset;
processing, by a video processor, the video asset based on the editing instructions to provide an edited video asset; and
performing at least one of storing, displaying or publishing the edited video asset.

2. The method according to claim 1, further comprising sending client editing information to the remote video editor; wherein the client editing information assist the remote editor to edit the compressed video asset.

3. The method according to claim 2 wherein the client editing information is selected from a group consisting of: a name of the video asset, a date in which the video asset was obtained, text to be included in the edited video asset, a picture to be included in the video asset, and a desired length of the edited video asset.

4. The method according to claim 2 wherein the client editing information is selected from a group consisting of: a type of event that is captured by the video asset, an importance of dialogue captured in the video asset.

5. The method according to claim 2 wherein the client editing information is selected from a group consisting of: items of interest captured in the video asset; pictures of items of interest captured in the video asset, a desired format of the edited video asset, and desired style of the edited video asset.

6. The method according to claim 1, further comprising:
receiving editing remarks from a user in response to a display of the edited video asset;
transmitting to the remote video editor the editing remarks;
requesting the remote video editor to edit the compressed video asset based on the editing remarks;
receiving updated editing instructions from the remote video editor;
processing the edited video asset based on the additional editing instructions to provide a re-edited video asset; and
performing at least one of storing, displaying or publishing the edited video asset.

7. The method according to claim 1, further comprising:
browsing to a web site that stores an edited second resolution video asset, wherein the edited second resolution video asset is generated by applying the editing instructions on the compressed video asset;
displaying the edited second resolution video asset;
receiving annotations that relate to a content of the edited second resolution video asset;
sending to the remote editor the annotation;
receiving annotation related editing instructions from the remote video editor that reflect the annotations;
processing the edited video asset based on the annotation related editing instructions to provide a re-edited video asset; and
storing or displaying the re-edited video asset.

8. The method according to claim 1, comprising:
generating client preference information reflecting client editing information generated by a client in response to different video assets; and
transmitting to the remote editor the client preference information.

9. The method according 1, comprising uploading the edited video asset to video sharing web sites.

10. The method according to claim 1, comprising requesting the remote editor to apply at least one of the following operations during the editing of the compressed video asset: face detection, scene detection, shake prevention, color correction, audio improvements and adjustments, beat detection, poor quality video identification.

11. A video processing system, the system comprises:
a video retriever for obtaining a video asset of a first resolution;
a compressing module for compressing the video asset to provide a compressed video asset of a second resolution that is lower than the first resolution;
a transmitter for transmitting the compressed video asset to a remote video editor;
a receiver for receiving editing instructions from the remote video editor, the editing instructions are generated by the remote editor when editing the compressed video asset;
a video processor for processing the video asset based on the editing instructions to provide an edited video asset; and
at least one component out of a memory unit and a display, the memory unit is configured to store the edited video asset and the display is configured to display the edited video asset.

12. The method according to claim 11, wherein the transmitter is configured to send client editing information to the remote video editor; wherein the client editing information assist the remote editor to edit the compressed video asset.

13. The video processing system according to claim 12 wherein the client editing information is selected from a group consisting of: a name of the video asset, a date in which the video asset was obtained, text to be included in the edited video asset, a picture to be included in the video asset, and a desired length of the edited video asset.

14. The video processing system according to claim 12 wherein the client editing information is selected from a group consisting of: a type of event that is captured by the video asset, an importance of dialogue captured in the video asset.

15. The video processing system according to claim 12 wherein the client editing information is selected from a group consisting of: items of interest captured in the video asset; pictures of items of interest captured in the video asset, a desired format of the edited video asset, and desired style of the edited video asset.

16. The video processing system according to claim 11 is further configured to:
receive editing remarks from a user in response to a display of the edited video asset;
transmit to the remote video editor the editing remarks;
request the remote video editor to edit the compressed video asset based on the editing remarks;
receive updated editing instructions from the remote video editor;
process the edited video asset based on the additional editing instructions to provide a re-edited video asset; and
perform at least one of storing, displaying or publishing the edited video asset.

17. The video processing system according to claim 11 is further configured to:
enable browsing to a web site that stores an edited second resolution video asset, wherein the edited second resolution video asset is generated by applying the editing instructions on the compressed video asset;
display the edited second resolution video asset;
receive annotations that relate to a content of the edited second resolution video asset;
send to the remote editor the annotation;
receive annotation related editing instructions from the remote video editor that reflect the annotations;
process the edited video asset based on the annotation related editing instructions to provide a re-edited video asset; and
store or displaying the re-edited video asset.

18. The video processing system according to claim 11 is further configured to:
generate client preference information reflecting client editing information generated by a client in response to different video assets; and
transmit to the remote editor the client preference information.

19. The video processing system according 11, further configured to upload the edited video asset to video sharing web sites.

20. The video processing system according to claim 11 is further configured to request the remote editor to apply at least one of the following operations during the editing of the compressed video asset: face detection, scene detection, shake prevention, color correction, audio improvements and adjustments, beat detection, poor quality video identification.

21. A method for editing a video asset, the method comprises:
receiving, by a remote video editor, a compressed video asset and a request, from a user that sent the compressed video asset, to edit the compressed video asset;
generating editing instructions, by the remote video editor, for editing the compressed video asset; and
transmitting the editing instructions to the user.

22. The method according to claim 21 further comprises:
receiving editing remarks from the user;
editing the compressed video asset based on the editing remarks to provide updated editing instructions; and
transmitting the updated editing instructions to the user.

23. A method for providing a video editors marketplace, comprising:
aggregating video editor information for multiple video editors, the video editor information comprises at least one of the list: a price list, reviews and comments by past customers and video editing samples;
allowing a user to select a preferred video editor out of the multiple video editors; and
providing an agreement between a selected video editor and the user.

24. The method of claim 23 further comprises receiving a video asset from the user and forwarding the video asset to the selected video editor.
